(19) United States
(12) Patent Application Publication
(10) Pub. No.: US 2017/0354183 A1
(43) Pub. Date: Dec. 14, 2017

(54) ELECTRONIC CIGARETTE, BLUETOOTH ASSEMBLY THEREOF, AND SMOKING INFORMATION ACQUISITION SYSTEM

(71) Applicant: Qiuming Liu, Shenzhen, Guangdong (CN)

(72) Inventor: Qiuming Liu, Shenzhen, Guangdong (CN)

(21) Appl. No.: 15/505,918

(22) PCT Filed: Aug. 29, 2014
(86) PCT No.: PCT/CN2014/085607

§ 371 Date: Feb. 22, 2017

(51) Int. Cl. A24F 47/00; H04W 4/00; H02J 7/00

(52) U.S. Cl. CPC A24F 47/008; H02J 7/0054; H04W 4/008

(57) ABSTRACT

The present application discloses an electronic cigarette, a Bluetooth assembly thereof, and a smoking information acquisition system, the electronic cigarette comprises an electronic cigarette body; the electronic cigarette body is provided with an atomization assembly and a battery assembly, the electronic cigarette further comprises a Bluetooth assembly configured for communicating with an external terminal, two ends of the Bluetooth assembly are detachably connected with the atomization assembly and the battery assembly respectively; the Bluetooth assembly comprises a microcontroller, a Bluetooth transceiver module, a voltage detection module and a current detection module. The Bluetooth assembly obtains output power information and smoking data of a user through the microcontroller, the user knows his/her own smoking situation and can adjust an output power of the electronic cigarette conveniently through the external terminal to control the smoke amount of the electronic cigarette.

### FIELD OF THE INVENTION

The present invention relates to the field of electronic cigarettes, and more particularly to an electronic cigarette, a Bluetooth assembly thereof, and a smoking information acquisition system and method.

### BACKGROUND OF THE INVENTION

An electronic cigarette, as a safety and health alternative to tobacco, is more widely used in a daily life.

An existing electronic cigarette generally comprises a battery assembly and an atomization assembly. The existing electronic cigarette uses to heat smoke oil to make the smoke oil atomized and generate smoke, thus to provide an alternative to a traditional cigarette for a smoker.

The most existing electronic cigarettes just exist as independent entities and do not have independent wireless transmitting modules, so that the existing electronic cigarettes cannot communicate with terminals. Thus the existing electronic cigarettes and other terminals cannot communicate with each other or be connected with other terminals to transfer data. When users use the existing electronic cigarettes, they cannot know their own smoking situation through the terminals, such as how many smokes they inhale every day, volume of each smoke, a smoking time distribution and so on.

### SUMMARY OF THE INVENTION

Aiming at the technical problem that the above electronic cigarette in the prior art does not have an independent wireless transmitting module and cannot communicate with an external terminal, the present invention provides an electronic cigarette, a Bluetooth assembly of the electronic cigarette, and a smoking information acquisition system and method.

The technical solutions adopted by the present invention to solve the technical problem is to provide an electronic cigarette, comprising an electronic cigarette body; the electronic cigarette body is provided with an atomization assembly configured for atomizing smoke oil and a battery assembly configured for supplying electrical power to internal components of the electronic cigarette body, wherein the electronic cigarette further comprises a Bluetooth assembly configured for communicating with an external terminal, the Bluetooth assembly is located between the atomization assembly and the battery assembly, and two ends of the Bluetooth assembly are detachably connected with the atomization assembly and the battery assembly respectively;

the Bluetooth assembly comprises a microcontroller, a Bluetooth transceiver module, a voltage detection module and a current detection module;

the voltage detection module is configured for detecting a load voltage when the electronic cigarette works and sending the load voltage to the microcontroller;

the current detection module is configured for detecting a load current when the electronic cigarette works and sending the load current to the microcontroller;

the microcontroller is configured for obtaining output power information when the electronic cigarette works according to the load voltage and the load current, and controlling the Bluetooth transceiver module to transfer the output power information;

the Bluetooth transceiver module is connected with the microcontroller, and the Bluetooth transceiver module is configured for establishing a Bluetooth connection with the external terminal and transferring the output power information to the external terminal under control of the microcontroller.

Preferably, the Bluetooth assembly further comprises a smoking signal detection module;

the smoking signal detection module is configured for detecting a smoking signal of the electronic cigarette and sending the smoking signal to the microcontroller;

the microcontroller is configured for obtaining a smoking data of the electronic cigarette according to the smoking signal and controlling the Bluetooth transceiver module to transfer the smoking data;

the Bluetooth transceiver module is connected with the microcontroller, and the Bluetooth transceiver module is configured for establishing the Bluetooth connection with the external terminal and transferring the smoking data to the external terminal under control of the microcontroller.

Preferably, the microcontroller is provided with a timing unit, a counting unit and a storage unit;

the timing unit is configured for recording a duration that the smoking signal is collected every time and storing the duration in the storage unit;

the counting unit is configured for recording times that smoking signals are received and storing the times in the storage unit.

Preferably, the smoking data comprises the duration that the smoking signal is collected every time and the times that smoking signals are received.

Preferably, the external terminal obtains a smoking time distribution and smoking times in a present time of a user according the smoking data, and obtains a smoking rule of the user through a statistical analysis.

Preferably, the battery assembly comprises a smoking sensor or a button switch; the smoking signal is generated by the smoking sensor or the button switch.

Preferably, the Bluetooth assembly further comprises a power battery, a charging management module and a stabilivolt module;

the charging management module is configured for achieving functions of overvoltage protection and charging management;

the power battery is configured for supplying electrical power to internal components of the Bluetooth assembly;

the stabilivolt module is configured for converting a voltage of the power battery and supplying a converted voltage to the microcontroller.

Preferably, the Bluetooth assembly further comprises a display module configured for indicating signals.

Preferably, the Bluetooth assembly further comprises a power adjustment module;

the Bluetooth transceiver module is further configured for receiving a power adjustment instruction sent by the external terminal;

the microcontroller controls the power adjustment module to adjust a output power of the electronic cigarette according the power adjustment instruction.

Preferably, the Bluetooth assembly further comprises a switch module;

the switch module is configured for controlling the Bluetooth assembly on and off, and controlling the Bluetooth assembly to send or receive information.

Preferably, the microcontroller is a chip, and a model of the chip is nRF51822.

Preferably, a fifth pin of the microcontroller is connected with an output port O+ of the battery assembly via a resistor R1 to detect a smoking signal.

Preferably, the current detection module comprises a resistor R7;

one end of the resistor R7 is connected with an output port O− of the battery assembly, and the other end of the resistor R7 is connected with a tenth pin of the microcontroller and a heating wire in the atomization assembly respectively.

Preferably, the voltage detection module comprises a resistor R2 and a resistor R3 connected in series between an output port O+ of the battery assembly and a ground, and a node in a series connection of the resistor R2 and the resistor R3 is connected with a fourth pin of the microcontroller.

Preferably, the Bluetooth transceiver module comprises a capacitor C5, a inductor L3, a inductor L1, a resistor R4, a inductor L2 and a capacitor C3;

a 32nd pin of the microcontroller is connected with one end of the capacitor C5, the other end of the capacitor C5 is connected with one end of the inductor L3, the other end of the inductor L3 is connected with the resistor R4;

a 31st pin of the microcontroller is connected with the 32nd pin via the inductor L1; one end of the inductor L2 is connected with the 31st pin of the microcontroller, the other end of the inductor L2 is connected with one end of the capacitor C3, the other end of the capacitor C3 is connected to a ground.

In a second aspect, the present application further provides a smoking information acquisition system, comprising the electronic cigarette above and an external terminal;

the electronic cigarette is configured for collecting information of the load voltage and the load current, and transferring the load voltage and the load current to the external terminal;

the external terminal is configured for feeding back information to a user according to the load voltage and the load current.

Preferably, the external terminal is further configured for setting working parameters of the electronic cigarette and transferring the working parameters to the electronic cigarette;

the electronic cigarette is further configured for working according to the working parameters.

In a third aspect, the present application further provides a Bluetooth assembly used in an electronic cigarette, being detachably connected with an atomization assembly and a battery assembly of the electronic cigarette, the Bluetooth assembly comprises a microcontroller, a Bluetooth transceiver module, a voltage detection module and a current detection module;

the voltage detection module is configured for detecting a load voltage when the electronic cigarette works and sending the load voltage to the microcontroller;

the current detection module is configured for detecting a load current when the electronic cigarette works and sending the load current to the microcontroller;

the microcontroller is configured for obtaining output power information when the electronic cigarette works according to the load voltage and the load current, and controlling the Bluetooth transceiver module to transfer the output power information;

the Bluetooth transceiver module is connected with the microcontroller, and the Bluetooth transceiver module is configured for establishing a Bluetooth connection with the external terminal and transferring the output power information to the external terminal under control of the microcontroller.

Preferably, the Bluetooth assembly further comprises a power battery, a charging management module and a stabilivolt module;

the charging management module is configured for achieving functions of overvoltage protection and charging management;

the power battery is configured for supplying electrical power to internal components of the Bluetooth assembly;

the stabilivolt module is configured for converting a voltage of the power battery and supplying a converted voltage to the microcontroller;

the Bluetooth assembly further comprises a display module configured for indicating signals;

the Bluetooth assembly further comprises a smoking signal detection module;

the smoking signal detection module is configured for detecting a smoking signal of the electronic cigarette and sending the smoking signal to the microcontroller;

the microcontroller is configured for obtaining a smoking data of the electronic cigarette according to the smoking signal and controlling the Bluetooth transceiver module to transfer the smoking data;

the Bluetooth transceiver module is connected with the microcontroller, and the Bluetooth transceiver module is configured for establishing the Bluetooth connection with the external terminal and transferring the smoking data to the external terminal under control of the microcontroller.

Preferably, threads can be provided on two connecting ends of the Bluetooth assembly respectively to be matched to the atomization assembly and the battery assembly.

In a fourth aspect, the present application further provides a smoking information acquisition method, using the electronic cigarette above and an external terminal to collect smoking information;

the electronic cigarette comprises an electronic cigarette body, the electronic cigarette body is provided with an atomization assembly configured for atomizing smoke oil and a battery assembly configured for supplying electrical power to internal components of the electronic cigarette body;

the electronic cigarette further comprises a Bluetooth assembly configured for communicating with the external terminal, and the Bluetooth assembly is detachably connected with the atomization assembly and the battery assembly;

the Bluetooth assembly comprises a microcontroller, a Bluetooth transceiver module, a voltage detection module and a current detection module;

the voltage detection module detects a load voltage when the electronic cigarette works and sends the load voltage to the microcontroller;

the current detection module detects a load current when the electronic cigarette works and sends the load current to the microcontroller;

the microcontroller obtains output power information when the electronic cigarette works according to the load voltage and the load current, and controls the Bluetooth transceiver module to transfer the output power information;

the Bluetooth transceiver module establishes a Bluetooth connection with the external terminal and transfers the output power information to the external terminal under control of the microcontroller;

the external terminal is configured for feeding back information to a user according to the output power information.

The present invention provides an electronic cigarette, a Bluetooth assembly of the electronic cigarette, and a smoking information acquisition system and method, which can be achieved the following advantageous effects: the electronic cigarette is provided with a Bluetooth assembly, the Bluetooth assembly obtains output power information of the electronic cigarette, a smoking data of a user and so on through a microcontroller, the output power information and the smoking data is transferred to an external terminal through a Bluetooth transceiver module, thus the user knows his own smoking situation through the external terminal, such as smoking times in a present time, volume of each smoke, a smoking time distribution and so on, so that the user can clearly grasp his own smoking situation, it is facilitate for the user to adjust smoking habit according to his situation and make the user keep in good physical condition. Meanwhile, it improves interests in smoking the electronic cigarette for the user and brings experience different from smoking a traditional cigarette in the process of smoking the electronic cigarette. On the other side, the Bluetooth assembly is detachably connected with the atomization assembly and the battery assembly respectively, this structure design is beneficial for the Bluetooth assembly to be installed and detached, if the user needs the electronic cigarette to communicate, he can make the Bluetooth assembly installed between the atomization assembly and the battery assembly, if the user needs not the electronic cigarette to communicate, he can make the Bluetooth assembly detached, it does not influence normal working of the electronic cigarette; and when the user needs to change the electronic cigarette, he can discharge the Bluetooth assembly, and install the Bluetooth assembly to other electronic cigarettes with the same connection mode. Thus, it prevents smoking information from being leaked when the user discards the electronic cigarette with a communication component, so that it is better to avoid data of personal smoking situation and physical condition to be leaked and protect personal privacy. When only the user really needs a Bluetooth function, the Bluetooth assembly is bought by the user, and one Bluetooth assembly can be used in different electronic cigarettes (interfaces of the electronic cigarettes match an interface of the Bluetooth assembly), thus to save costs for the user. The user can easily adjust an output power of the electronic cigarette to control smoke volume of the electronic cigarette through an external terminal or equipment. The user can easily know his smoking traits and rules through the external terminal; and the smoking traits and rules of the user can be collected through a special APP installed in the external terminal, so that manufacturers can easily obtain rules that the user uses the electronic cigarette, then obtain demand data of the user, thus to manufacture electronic cigarettes with different properties to meet demands of the user easily.

### BRIEF DESCRIPTION OF THE DRAWINGS

FIG. 1 illustrates a functional block diagram of an electronic cigarette in a first preferred embodiment of the present invention when the electronic cigarette communicates with an external terminal;

FIG. 2 illustrates a functional block diagram of a Bluetooth assembly in the first preferred embodiment of the present invention;

FIG. 3 illustrates a schematic circuit diagram of the Bluetooth assembly without a smoking signal detection module, a voltage detection module, a charging management module and a stabilivolt module in the first preferred embodiment of the present invention;

FIG. 4 illustrates a schematic circuit diagram of the smoking signal detection module and the voltage detection module of the Bluetooth assembly in the first preferred embodiment of the present invention;

FIG. 5 illustrates a schematic circuit diagram of the charging management module and the stabilivolt module of the Bluetooth assembly in the first preferred embodiment of the present invention;

FIG. 6 illustrates a schematic circuit diagram of a battery assembly of the electronic cigarette in the first preferred embodiment of the present invention;

FIG. 7 illustrates a schematic circuit diagram of the Bluetooth assembly in a second preferred embodiment of the present invention.

### DETAILED DESCRIPTION OF THE PREFERRED EMBODIMENT

To make the technical features, objective and effects of the invention more clearly understood, the invention is to be further described with reference to the accompanying drawings and embodiments.

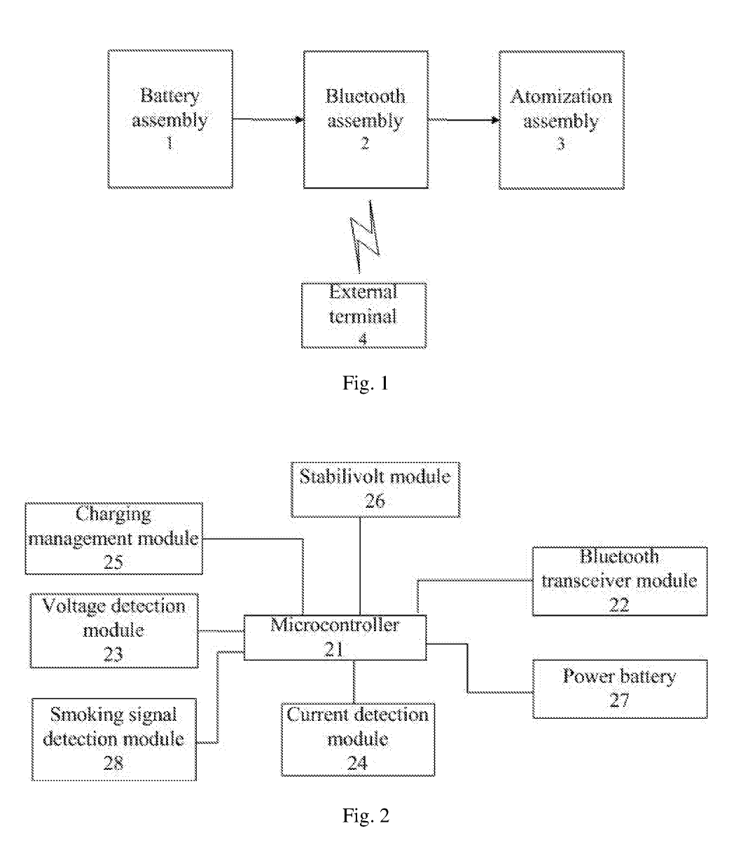

FIG. 1 illustrates a functional block diagram of an electronic cigarette in a first preferred embodiment of the present invention. The electronic cigarette in the embodiment of the present invention comprises an electronic cigarette body. The electronic cigarette body is provided with an atomization assembly 3 configured for atomizing smoke oil, and a battery assembly 1 configured for supplying electrical power to internal components of the electronic cigarette body. The atomization assembly 3 comprises a heating wire, and the heating wire is configured for heating to atomize the smoke oil. The battery assembly 1 comprises a battery configured for supplying electrical power to the heating wire.

The electronic cigarette in the embodiment of the present invention further comprises a Bluetooth assembly 2 configured for communicating with an external terminal, the Bluetooth assembly 2 is located between the atomization assembly 3 and the battery assembly 1, and two ends of the Bluetooth assembly 2 are detachably connected with the atomization assembly 3 and the battery assembly 1 respectively. Preferably, in the embodiment of the present invention, a connection mode that the Bluetooth assembly 2 is detachably connected with the atomization assembly 3 and the battery assembly 1 respectively is threaded connection. Threads can be provided on two connecting ends of the Bluetooth assembly 2 respectively to be matched to the atomization assembly 3 and the battery assembly 1. Certainly, a mode of a detachable connection can be a mode of magnetic connection or clamping connection etc, not limit here.

Therefore, the electronic cigarette in the embodiment of the present invention adds the Bluetooth assembly 2 with a Bluetooth communication function, and then adds functions of Bluetooth transceiver, information collection, information processing and storage, the Bluetooth assembly 2 can send smoking information of the electronic cigarette to the external terminal 4. Therefore, a user can easily know his smoking traits and rules through the external terminal 4; and the smoking traits and rules of the user can be collected through a special APP installed in the external terminal 4, so that manufacturers can easily obtain using rules of the electronic cigarette of the user, then obtain demand data of the user, thus to manufacture electronic cigarettes with different properties to meet demands of the user easily.

In the embodiment of the present invention, when the user needs to change the electronic cigarette, he can discharge the Bluetooth assembly 2, and install the Bluetooth assembly 2 to other electronic cigarettes with the same connection mode. Thus, it prevents smoking information from being leaked when the user discards the electronic cigarette with the Bluetooth assembly 2. When the user wants to use the electronic cigarette with a communicating function in normal times, he can connect the Bluetooth assembly 2 to other electronic cigarettes with the same connection mode, not every electronic cigarette need has the Bluetooth assembly 2, thus to save costs of the electronic cigarette, and to change and carry the electronic cigarette conveniently for the user.

Furthermore, the Bluetooth assembly 2 is detachably connected between the atomization assembly 3 and the battery assembly 1, thus to prevent electromagnetic wave generated by a signal that the Bluetooth assembly 2 sends from interfering an airflow sensor configured for generating a smoking signal in the battery assembly 1 when the Bluetooth assembly 2 is placed in an end region of the battery assembly 1 for a long time, the interference may lead to a situation of spurious triggering of the electronic cigarette; and to prevent a situation that the smoke oil leaked from the Bluetooth assembly 2 make the Bluetooth assembly 2 short out easily when the Bluetooth assembly 2 is placed on an end of the battery assembly 1 connected with the Bluetooth assembly 2 for a long time.

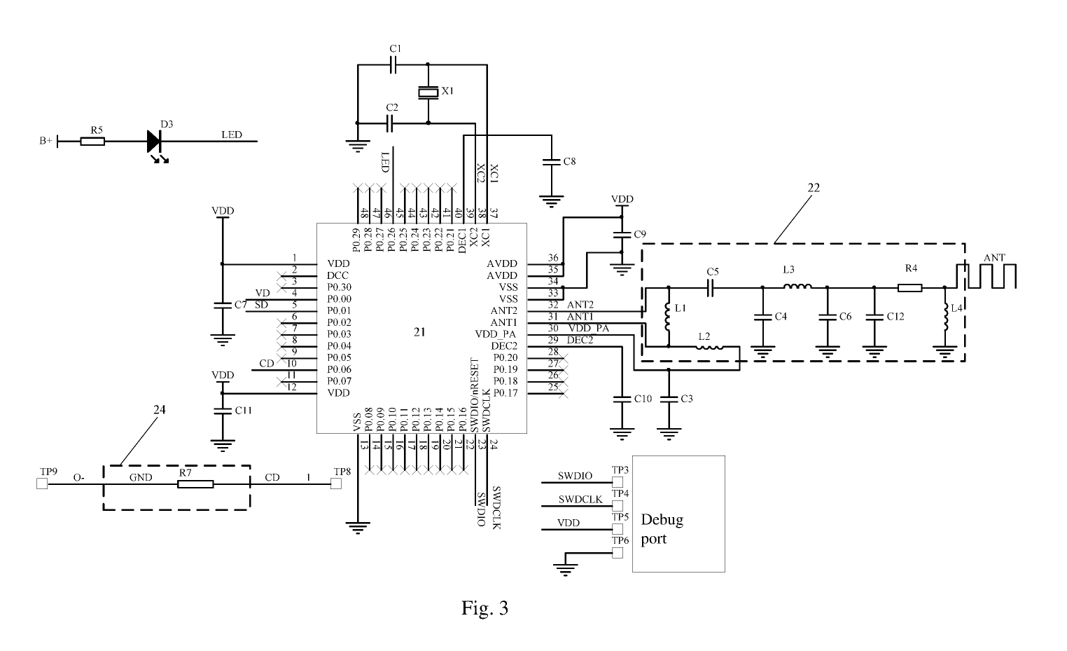

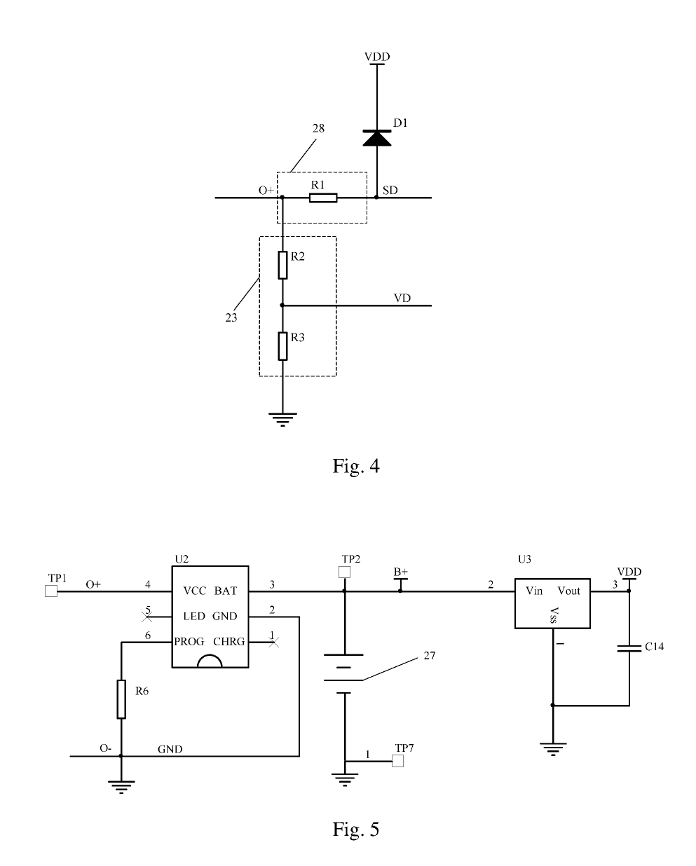

The structure and working principle of the Bluetooth assembly in the first preferred embodiment of the present invention is to be further described with reference to FIG. 2-FIG. 5.

As shown in the FIG. 2, the Bluetooth assembly in the embodiment of the present invention comprises a microcontroller 21, a Bluetooth transceiver module 22, a voltage detection module 23, a current detection module 24, a charging management module 25, a stabilivolt module 26, a power battery 27 and a smoking signal detection module 28.

FIG. 3-FIG. 5 illustrate a schematic circuit diagram of the Bluetooth assembly in the embodiment of the present invention. The microcontroller 21 is a chip, and a model of the chip is nRF51822. In the embodiment, the Bluetooth transceiver module 22 is partly integrated in the chip nRF51822, furthermore, the Bluetooth transceiver module 22 further comprises a capacitor C5, a inductor L3, a inductor L1, a resistor R4, a inductor L2 and a capacitor C3; a 32nd pin of the microcontroller is connected with one end of the capacitor C5, the other end of the capacitor C5 is connected with one end of the inductor L3, the other end of the inductor L3 is connected with the resistor R4; a 31st pin of the microcontroller is connected with the 32nd pin via the inductor L1; one end of the inductor L2 is connected with the 31st pin of the microcontroller, the other end of the inductor L2 is connected with one end of the capacitor C3, the other end of the capacitor C3 is connected to a ground. Understandably, the Bluetooth transceiver module 22 also can be realized by a separate chip in the prior art.

The current detection module 24 comprises a resistor R7. Specifically, one end of the resistor R7 is connected with an output port O− of the battery assembly, the other end of the resistor R7 is connected with a 10th pin of the microcontroller 21 and the heating wire in the atomization assembly 3 respectively. Understandably, TP9 and TP8 in the FIG. 3 are ports, the TP9 is electrically connected with the output port O− of the battery assembly, and the TP8 is electrically connected with the heating wire in the atomization assembly. The current detection module 24 is configured for detecting a magnitude of a current that flows through the heating wire, namely a magnitude of a load current when the battery assembly supplies electrical power to the heating wire in the atomization assembly.

The voltage detection module 23 comprises a resistor R2 and a resistor R3 connected in series between an output port O+ of the battery assembly and the ground, and a node in a series connection of the resistor R2 and the resistor R3 is connected with a fourth pin of the microcontroller 21. The voltage detection module 23 is configured for detecting a load voltage, namely a voltage of the heating wire when the battery assembly supplies electrical power to the heating wire in the atomization assembly.

In the embodiment, the microcontroller 21 can obtain output power information of the electronic cigarette according to the load current detected by the current detection module 24 and the load voltage detected by the voltage detection module 23. While, an output power is corresponding to a smoking volume, so that the smoking volume that the user smokes every times can be obtained. The microcontroller 21 transfers the output power information to the external terminal through Bluetooth, and then the external terminal can obtain the output power information (namely, information of the smoking volume) of the electronic cigarette.

Furthermore, a fifth pin of the microcontroller 21 is connected with the output port O+ of the battery assembly via a resistor R1 to detect a smoking signal. The microcontroller 21 can obtain the smoking data of the electronic cigarette according the smoking signal, and control the Bluetooth transceiver module 22 to transfer the smoking data to the external terminal. Specifically, in the embodiment, the microcontroller 21 has built-in a RTC function, the microcontroller 21 is provided with a timing unit, a counting unit and a storage unit. The timing unit is configured for recording a duration that the smoking signal is collected every time and storing the duration in the storage unit. The counting unit is configured for recording times that smoking signals are received and storing the times in the storage unit. Thus, the smoking data comprises the duration that the smoking signal is collected every time and the times that smoking signals are received. The external terminal obtains a smoking time distribution and smoking times in a present time of the user according the smoking data, and obtains smoking rules of the user through statistical analysis.

The charging management module 25 is realized by a linear charging management chip U2, the charging management module 25 is configured for achieving a function of overvoltage protection and charging management. TP1 is the output port O+ of the battery assembly.

The stabilivolt module 26 is a chip U3 (low-dropout linear regulator), the stabilivolt module 26 converts a voltage of the power battery from 3.3V-4.2V to 3V to power the microcontroller.

In the embodiment, the Bluetooth assembly 2 further comprises a display module configured for indicating signals. As shown in the FIG. 3, in the embodiment, the display module comprises a light-emitting diode D3, an anode of the light-emitting diode D3 is connected with a positive electrode of a power battery via a resistor R5, a cathode of the light-emitting diode D3 is connected with a 45th pin of the microcontroller 21. Indications of the signals comprise a lighting indication when a Bluetooth connection is successful, a lighting indication when the connection is fault or a lighting indication when data is transferred, not limit in the embodiment of the present invention.

In the embodiment of the present invention, a 23rd pin and a 24th pin of the microcontroller 21 and debug ports TP3-TP6 formed by VDD and the ground are configured for debugging the microcontroller.

In the embodiment, the Bluetooth assembly 2 is provided with a power battery 27. The power battery 27 is configured for supplying electrical power to internal components of the Bluetooth assembly 2. In the embodiment, because of a standalone power battery 27, the power battery 27 can supplies electrical power to the Bluetooth assembly 2 to ensure that the electronic cigarette stay connected to the external terminal. The power battery 27 also can be controlled by the microcontroller 21, when the user stops smoking, no voltage is detected in the fifth pin of the microcontroller 21, the microcontroller 21 controls the power battery 27 to stop supplying electrical power to the microcontroller 21, thus to save electric energy of the power battery 27.

In the embodiment, the Bluetooth assembly 2 is further provided with a switch module; the switch module is configured for controlling the Bluetooth assembly on and off, and controlling the Bluetooth assembly 2 to send or receive information, for example, when the switch module is pressed once, the Bluetooth assembly 2 is turned on or off, when a frequency that the switch module is pressed in a preset time is greater than a preset frequency, the Bluetooth assembly 2 sends out the smoking data. Thus, if the user can control the Bluetooth assembly 2 through the switch module, the switch module can be a button switch, and the button switch can be connected to any I/O pin of the microcontroller 21 to control the Bluetooth assembly 2.

In the embodiment, a connection between the Bluetooth assembly and the atomization assembly is a detachable connection, and a connection between the Bluetooth assembly and the battery assembly is a detachable connection. When the Bluetooth assembly is not needed, the atomization assembly can be connected to the battery assembly to form an integrated electronic cigarette. specifically, when the atomization assembly is directly connected to the battery assembly, the output port O+ of the battery assembly is connected to one end of the heating wire, and the output port O− of the battery assembly is connected to the other end of the heating wire, thus to supply electrical power to the heating wire. When a Bluetooth function is needed, the Bluetooth assembly is connected between the battery assembly and the atomization assembly, thus the Bluetooth assembly, the battery assembly and the atomization assembly constitutes a circuit shown in FIG. 3-5.

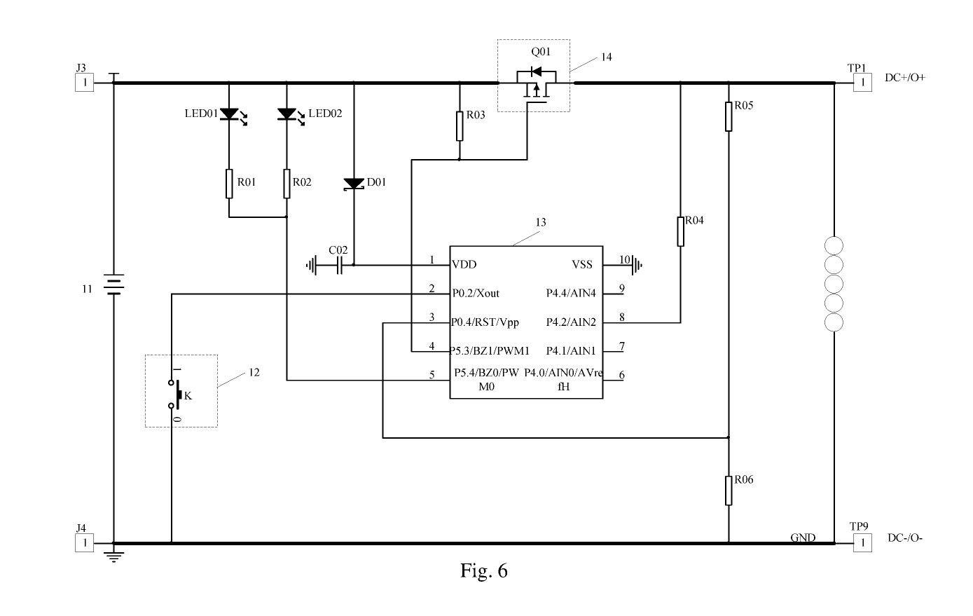

FIG. 6 illustrates a schematic circuit diagram of the battery assembly of the electronic cigarette in the first preferred embodiment of the present invention. In the embodiment, the battery assembly comprises a battery 11, a smoking sensor or a button switch 12, a control module 13 and a switch unit 14. A model of the control module 13 is SN8P2711. The switch unit 14 is realized by a MOSFET Q01. Ports TP1 and TP9 can be directly connected to the heating wire in the atomization assembly, thus, when the control module 13 receives the smoking signal sent by the smoking sensor or the button switch 12, the control module 13 controls the MOSFET Q01 of the switch unit 14 to be conducted, so that the battery 11 supplies electrical power to the heating wire to make the heating wire hot, thus to atomize the smoke oil. Furthermore, the ports TP1 and TP9 also can be connected to one end of the Bluetooth assembly 2, the heating wire in the atomization assembly 3 is connected to the other end of the Bluetooth assembly 2, namely the Bluetooth assembly shown in the FIG. 3-5 is connected to the battery assembly shown in the FIG. 6.

Specifically, if a device that generates the smoking signal is the smoking sensor, the smoking sensor is configured for inducing a change of air pressure in an airflow channel of the electronic cigarette, and sending the smoking signal to the control module 13 according to the change of the air pressure in the airflow channel; the control module 13 is configured for controlling the MOSFET Q01 of the switch unit 14 to be conducted to power the heating wire in the atomization assembly 3 according to the smoking signal sent by the smoking sensor. If a device that generates the smoking signal is the switch button, when the switch button is pressed, the smoking signal is generated, the control module 13 controls the MOSFET Q01 of the switch unit 14 to be conducted to power the heating wire in the atomization assembly 3 according to the smoking signal sent by the smoking sensor.

In a working process, when the smoking sensor or the button switch 12 generates the smoking signal, the control module 13 controls the switch unit 14 to be conducted, the voltage in the fifth pin of the microcontroller 21 changes, thus, the microcontroller 21 can detect the smoking signal. A moment that the fifth pin of the microcontroller 21 receives a voltage signal namely is a moment that acquires the smoking signal, a duration of the voltage signal namely is a duration that acquires the smoking signal every time. While, because of the fourth pin of the microcontroller 21 is connected to the node in the series connection of the resistor R2 and the resistor R3 of the voltage detection module 23, the microcontroller 21 can detect the load voltage when the battery assembly supplies electrical power. A current flows through the resistor R7 of the current detection module 24 namely is the load current. The microcontroller 21 obtains the output power information of the battery assembly according to the load voltage and the load current detected in the fourth pin and the fifth pin.

Specifically, after the battery assembly 1 and the atomization assembly 3 are connected to the Bluetooth assembly 2, the battery assembly 1 can supply electrical power to the atomization assembly 3. When the user uses the electronic cigarette, the battery assembly 1 supplies electrical power to the atomization assembly 3, a voltage is detected in the fifth pin of the microcontroller 21, at this time, the timing unit of the microcontroller 21 starts timing and records the duration that the smoking signal is acquired. The counting unit records times that smoking signals are received (i.e. puff number). While, the microcontroller 21 obtains the output power information of the battery assembly according to the load voltage and the load current detected in the fourth pin and the fifth pin. After the user stops smoking, the microcontroller 21 stores the smoking data of the user in the storage unit, meanwhile, the microcontroller 21 controls the Bluetooth transceiver module to send the smoking data and the output power information to the external terminal which has already been connected to the Bluetooth transceiver module. Certainly, the microcontroller 21 also can control the Bluetooth transceiver module to send the smoking data and the output power information to the external terminal when preset smoking times or a preset service time of the electronic cigarette is achieved, such as one day, one week or one month. A send mode and a send time of the smoking data and the output power information are not limit here.

In the embodiment, before the Bluetooth assembly 2 transfers data with the external terminal, a Bluetooth connection should be built. A way to build the Bluetooth connection is a technology in the prior art, not limit here.

In the embodiment of the present invention, the Bluetooth assembly sends the smoking data (comprises the duration that the smoking signal is acquired, times that smoking signals are received and so on) and the output power information to the external terminal through the Bluetooth transceiver module. When the external terminal receives information sent by the Bluetooth assembly, the external terminal analyzes and processes the information to provide useful information for the user. Specifically, a special APP is installed in the external terminal, the APP is paired with the Bluetooth assembly of the electronic cigarette through the Bluetooth connection. After the external terminal runs the APP, the external terminal can receive the information sent by the Bluetooth assembly of the electronic cigarette, thus the user can know his own smoking situation through the external terminal, such as a resistance of the heating wire in the atomization assembly 3, a number that smoke is inhaled, a smoking time distribution and so on. A smoking characteristic rule also can be summarized through the APP, for example, a time (such as one day) can be set, smoking habit of the user can be obtained according to the number that smoke is inhaled and the smoking time distribution obtained in a setting time, and a total smoking volume and a smoking volume for each smoke of the user in one day can be obtained combine with the output power information. The resistance of the heating wire can be obtained according to the load voltage and the load current; the number that smoke is inhaled is obtained by the counting unit in the microcontroller 21. The smoking time distribution can be obtained according to the duration that the smoking signal is acquired every time.

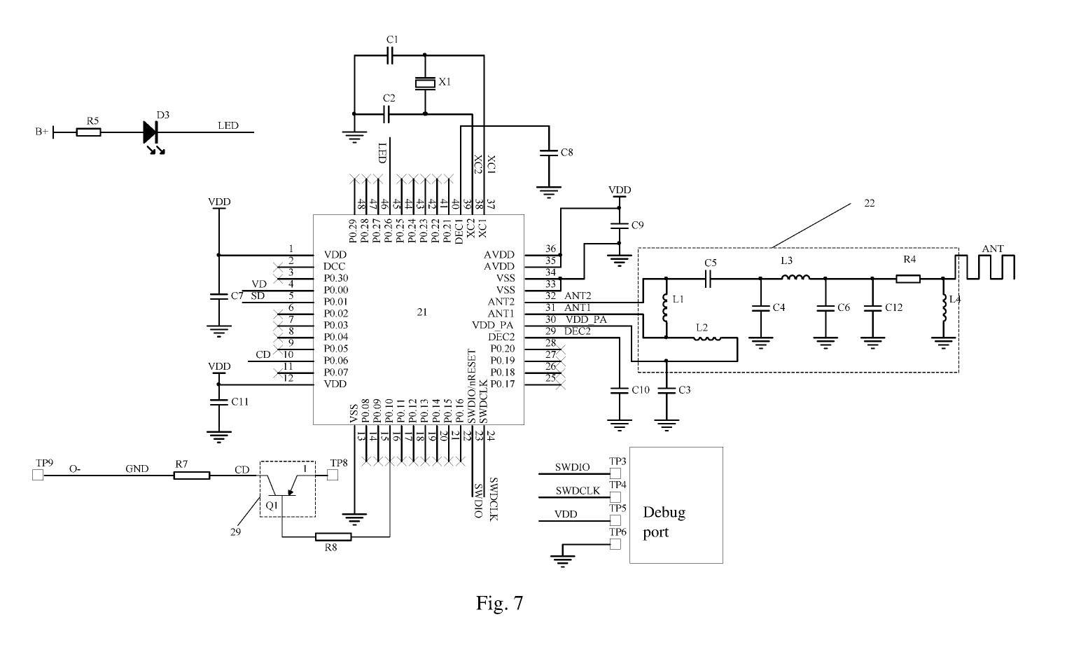

FIG. 7 illustrates a schematic circuit diagram of the Bluetooth assembly in a second preferred embodiment of the present invention. Difference between the Bluetooth assembly of the electronic cigarette in the second preferred embodiment of the present invention and the Bluetooth assembly in the first preferred embodiment above is that the Bluetooth assembly in the first preferred embodiment adds a power adjustment module 29. The power adjustment module 29 comprises a triode Q1, thus, in the embodiment, the Bluetooth assembly can receive an instruction sent by the external terminal and adjust an output power of the electronic cigarette according to the instruction. Specifically, in the embodiment, the triode Q1 is added. A base of the triode Q1 is connected to a 15th pin of the microcontroller 21 via a resistor R8; an emitter of the triode Q1 is connected to a port TP8; a collector of the triode Q1 is connected to one end of the resistor R7. The microcontroller 21 controls conducting states of the triode Q1 according to a detected load voltage and a detected load current, to realize that the battery of the electronic cigarette adjusts a supply voltage of the heating wire, to realize a control of the output power of the electronic cigarette, thus to control the smoking volume. Understandably, the user can set the output power through the external terminal, and then the external terminal sends the output power to the Bluetooth assembly of the electronic cigarette through Bluetooth, thus to realize adjustment of the output power of the electronic cigarette.

The present invention further provides a smoking information acquisition system, comprising the electronic cigarette in the embodiments above and an external terminal. The electronic cigarette uses the Bluetooth assembly in the first or second preferred embodiment. The electronic cigarette is configured for collecting information of the load voltage, the load current, the smoking signal and so on when the electronic cigarette works, and transferring the information to the external terminal; the external terminal is configured for obtaining smoking information and feeding back the smoking information to a user according to the information of the load voltage, the load current, the smoking signal and so on. The smoking information obtained by the external terminal comprises information of output power information, a smoking data of the electronic cigarette and so on. Furthermore, the external terminal is further configured for setting working parameters of the electronic cigarette and transferring the working parameters to the electronic cigarette; the electronic cigarette is further configured for working according to the working parameters. For example, the external terminal can set an output power of the electronic cigarette, after the electronic cigarette receives output power information, the electronic cigarette works according to a power set in the output power information, thus each smoking volume output by the electronic cigarette is controlled. Understandably, the working parameters can be set by the user.

The present invention further provides a smoking information acquisition method, using the electronic cigarette in the embodiments above and an external terminal to collect smoking information. The electronic cigarette comprises an electronic cigarette body, the electronic cigarette body is provided with an atomization assembly configured for atomizing smoke oil, and a battery assembly configured for supplying electrical power to internal components of the electronic cigarette body; the electronic cigarette further comprises a Bluetooth assembly configured for communicating with the external terminal, the Bluetooth assembly is detachably connected with the atomization assembly and the battery assembly respectively. The Bluetooth assembly comprises a microcontroller, a Bluetooth transceiver module, a voltage detection module and a current detection module.

In the smoking information acquisition method, the voltage detection module detects a load voltage when the electronic cigarette works and sends the load voltage to the microcontroller; the current detection module detects a load current when the electronic cigarette works and sends the load current to the microcontroller; the microcontroller obtains output power information when the electronic cigarette works according to the load voltage and the load current, and controls the Bluetooth transceiver module to transfer the output power information; the Bluetooth transceiver module establishes a Bluetooth connection with the external terminal and transfers the output power information to the external terminal under control of the microcontroller; the external terminal is configured for feeding back information to a user according to the output power information. The information obtained by the external terminal comprises information of the output power information, smoking data of the electronic cigarette and so on. Furthermore, the external terminal is further configured for setting working parameters of the electronic cigarette and transferring the working parameters to the electronic cigarette; the electronic cigarette is further configured for working according to the working parameters. For example, the external terminal can set the output power information of the electronic cigarette, after the electronic cigarette receives the output power information, the electronic cigarette works according to a power set in the output power information, thus each smoking volume output by the electronic cigarette is controlled.

Understandably, in the above embodiments of the present invention, the external terminal can be a hardware equipment with a variety of operating systems, such as mobile phone, tablet PC, PDA, desktop computer and so on.

Obviously, those with ordinary skill in the art can make various changes and modification for these embodiments without breaking away from the spirit and protection scope of the present invention. In this case, if these changes and modification for the present invention are within the scope of the claims of the present invention and its equivalent technology, the present invention is also intent to include these changes and modification.

1. An electronic cigarette comprising:
an electronic cigarette body being provided with an atomization assembly configured for atomizing smoke oil and a battery assembly configured for supplying electrical power to internal components of the electronic cigarette body;
a Bluetooth assembly configured for communicating with an external terminal, the Bluetooth assembly is defined between the atomization assembly and the battery assembly, and two ends of the Bluetooth assembly are detachably connected with the atomization assembly and the battery assembly respectively;
wherein the Bluetooth assembly comprises a microcontroller, a Bluetooth transceiver module, a voltage detection module and a current detection module;
wherein the voltage detection module is configured for detecting a load voltage when the electronic cigarette works and sending the load voltage to the microcontroller;
wherein the current detection module is configured for detecting a load current when the electronic cigarette works and sending the load current to the microcontroller;
wherein the microcontroller is configured for obtaining output power information when the electronic cigarette works according to the load voltage and the load current, and controlling the Bluetooth transceiver module to transfer the output power information; and
wherein the Bluetooth transceiver module is connected with the microcontroller, and the Bluetooth transceiver module is configured for establishing a Bluetooth connection with the external terminal and transferring the output power information to the external terminal under control of the microcontroller.

2. The electronic cigarette according to claim 1, wherein the Bluetooth assembly further comprises a smoking signal detection module;
wherein the smoking signal detection module is configured for detecting a smoking signal of the electronic cigarette and sending the smoking signal to the microcontroller;
wherein the microcontroller is configured for obtaining a smoking data of the electronic cigarette according to the smoking signal and controlling the Bluetooth transceiver module to transfer the smoking data; and
wherein the Bluetooth transceiver module is connected with the microcontroller, and the Bluetooth transceiver module is configured for establishing the Bluetooth connection with the external terminal and transferring the smoking data to the external terminal under control of the microcontroller.

3. The electronic cigarette according to claim 2, wherein the microcontroller is provided with a timing unit, a counting unit and a storage unit;
wherein the timing unit is configured for recording a duration that the smoking signal is collected every time and storing the duration in the storage unit; and
wherein the counting unit is configured for recording times that smoking signals are received and storing the times in the storage unit.

4. The electronic cigarette according to claim 3, wherein the smoking data comprises the duration that the smoking signal is collected every time and the times that the smoking signals are received.

5. The electronic cigarette according to claim 4, wherein the external terminal obtains a smoking time distribution and smoking times in a present time of a user according the smoking data, and obtains smoking rules of the user through a statistical analysis.

6. The electronic cigarette according to claim 2, wherein the battery assembly comprises a smoking sensor or a button switch; the smoking signal is generated by the smoking sensor or the button switch.

7. The electronic cigarette according to claim 1, wherein the Bluetooth assembly further comprises a power battery, a charging management module and a stabilivolt module;
wherein the charging management module is configured for achieving functions of overvoltage protection and charging management;
wherein the power battery is configured for supplying electrical power to internal components of the Bluetooth assembly; and
wherein the stabilivolt module is configured for converting a voltage of the power battery and supplying a converted voltage to the microcontroller.

8. The electronic cigarette according to claim 1, wherein the Bluetooth assembly further comprises a display module configured for indicating signals.

9. The electronic cigarette according to claim 1, wherein the Bluetooth assembly further comprises a power adjustment module;
wherein the Bluetooth transceiver module is further configured for receiving a power adjustment instruction sent by the external terminal; and
wherein the microcontroller controls the power adjustment module to adjust a output power of the electronic cigarette according the power adjustment instruction.

10. The electronic cigarette according to claims 1, wherein the Bluetooth assembly further comprises a switch module; and
wherein the switch module is configured for controlling the Bluetooth assembly on and off, and controlling the Bluetooth assembly to send or receive information.

11. The electronic cigarette according to claims 1, wherein the microcontroller is a chip, and a model of the chip is nRF51822.

12. The electronic cigarette according to claim 11, wherein a fifth pin of the microcontroller is connected with an output port O+ of the battery assembly via a resistor R1 to detect a smoking signal.

13. The electronic cigarette according to claim 11, wherein the current detection module comprises a resistor R7; and
wherein one end of the resistor R7 is connected with an output port O− of the battery assembly, and the other end of the resistor R7 is connected with a tenth pin of the microcontroller and a heating wire in the atomization assembly respectively.

14. The electronic cigarette according to claim 11, wherein the voltage detection module comprises a resistor R2 and a resistor R3 connected in series between an output port O+ of the battery assembly and a ground, and a node in a series connection of the resistor R2 and the resistor R3 is connected with a fourth pin of the microcontroller.

15. The electronic cigarette according to claim 11, wherein the Bluetooth transceiver module comprises a capacitor C5, a inductor L3, a inductor L1, a resistor R4, a inductor L2 and a capacitor C3;
wherein a 32nd pin of the microcontroller is connected with one end of the capacitor C5, the other end of the capacitor C5 is connected with one end of the inductor L3, the other end of the inductor L3 is connected with the resistor R4; and
wherein a 31st pin of the microcontroller is connected with the 32nd pin via the inductor L1; one end of the inductor L2 is connected with the 31st pin of the microcontroller, the other end of the inductor L2 is connected with one end of the capacitor C3, the other end of the capacitor C3 is connected to a ground.

16. A smoking information acquisition system, wherein comprising the electronic cigarette as described in claim 1 and an external terminal;
wherein the electronic cigarette is configured for collecting information of the load voltage and the load current, and transferring the load voltage and the load current to the external terminal; and
wherein the external terminal is configured for feeding back information to a user according to the load voltage and the load current.

17. The smoking information acquisition system according to claim 16, wherein the external terminal is further configured for setting working parameters of the electronic cigarette and transferring the working parameters to the electronic cigarette;
the electronic cigarette is further configured for working according to the working parameters.

18. A Bluetooth assembly used in an electronic cigarette, being detachably connected with an atomization assembly and a battery assembly of the electronic cigarette, wherein the Bluetooth assembly comprises a microcontroller, a Bluetooth transceiver module, a voltage detection module and a current detection module;
wherein the voltage detection module is configured for detecting a load voltage when the electronic cigarette works and sending the load voltage to the microcontroller;
wherein the current detection module is configured for detecting a load current when the electronic cigarette works and sending the load current to the microcontroller;
wherein the microcontroller is configured for obtaining output power information when the electronic cigarette works according to the load voltage and the load current, and controlling the Bluetooth transceiver module to transfer the output power information; and
wherein the Bluetooth transceiver module is connected with the microcontroller, and the Bluetooth transceiver module is configured for establishing a Bluetooth connection with the external terminal and transferring the output power information to the external terminal under control of the microcontroller.

19. The Bluetooth assembly according to claim 18, wherein the Bluetooth assembly further comprises a power battery, a charging management module and a stabilivolt module;
wherein the charging management module is configured for achieving functions of overvoltage protection and charging management;
wherein the power battery is configured for supplying electrical power to internal components of the Bluetooth assembly;
wherein the stabilivolt module is configured for converting a voltage of the power battery and supplying a converted voltage to the microcontroller;
wherein the Bluetooth assembly further comprises a display module configured for indicating signals;
wherein the Bluetooth assembly further comprises a smoking signal detection module;
wherein the smoking signal detection module is configured for detecting a smoking signal of the electronic cigarette and sending the smoking signal to the microcontroller;
wherein the microcontroller is configured for obtaining a smoking data of the electronic cigarette according to the smoking signal and controlling the Bluetooth transceiver module to transfer the smoking data; and
wherein the Bluetooth transceiver module is connected with the microcontroller, and the Bluetooth transceiver module is configured for establishing the Bluetooth connection with the external terminal and transferring the smoking data to the external terminal under control of the microcontroller.

20. (canceled)
